(19) United States
(12) Patent Application Publication
(10) Pub. No.: US 2025/0259100 A1
(43) Pub. Date: Aug. 14, 2025

(54) PREDICTING IMPLICIT DEVICE PARAMETERS FOR QUANTUM DEVICES USING TRAINED MACHINE LEARNING MODELS

(71) Applicant: Microsoft Technology Licensing, LLC, Redmond, WA (US)

(72) Inventors: Alexei BOCHAROV, Redmond, WA (US); Diego Olivier FERNANDEZ, Copenhagen (DK); Amin BARZEGAR, Redmond, WA (US); Roman Mykolayovych LUTCHYN, Santa Barbara, CA (US); Andrey ANTIPOV, Santa Barbara, CA (US); Georg Wolfgang WINKLER, Santa Barbara, CA (US); William Scott COLE, Jr., Sammamish, WA (US)

(21) Appl. No.: 18/628,705

(22) Filed: Apr. 6, 2024

Related U.S. Application Data
(60) Provisional application No. 63/624,376, filed on Jan. 24, 2024.

(51) Int. Cl. G06N 20/00; G06N 10/20; G06N 10/40

(52) U.S. Cl. CPC G06N 20/00; G06N 10/20; G06N 10/40

(57) ABSTRACT

Methods and systems for predicting the values of implicit device parameters for quantum devices are described. An example computer-implemented method for predicting values of implicit device parameters for a quantum device having nanowires is described. The computer-implemented method includes training a machine learning model to create a mapping between observable device aspects of quantum devices and at least one implicit device parameter associated with the quantum devices. The computer-implemented method further includes obtaining measurements data relating to the observable device aspects from a quantum device under observation. The computer-implemented method further includes using the trained machine learning model, processing the measurements data obtained from the observed quantum device to infer values for the at least one implicit device parameter associated with the observed quantum device.

### CROSS-REFERENCE TO A RELATED APPLICATION

This application claims the benefit of U.S. Provisional Application No. 63/624,376, filed Jan. 24, 2024, titled “SIMULATION-BASED EXTRACTION OF THE SPIN-ORBIT COUPLING AND CALIBRATION OF THE OPTIMAL TOPOLOGICAL GAP,” the entire contents of which are hereby incorporated herein by reference.

### BACKGROUND

Topological devices can be used to enable quantum computers. Such quantum computers require reliable reproduction of a stable topological phase of the matter that supports non-Abelian quasiparticles or defects and processes quantum information through protected operations, such as braiding. Quantum devices have both explicit device parameters, such as various voltages applied to the gates, and implicit device parameters. Implicit device parameters of quantum devices relate to those parameters that cannot be measured directly by simple measurement of the electrical or other properties of the quantum devices. A subset of such implicit device parameters could be measured but would require a substantial amount of time for the measurements associated with such implicit device parameters. Moreover, the measurement of certain device parameters may require fabrication of additional separate quantum devices, which is both time and resource consuming.

Accordingly, there is a need for improvements to systems and methods for predicting the values of implicit device parameters for quantum devices.

### SUMMARY

In one example, the present disclosure relates to a computer-implemented method for predicting values of implicit device parameters for a quantum device having nanowires. The computer-implemented method includes training a machine learning model to create a mapping between observable device aspects of quantum devices and at least one implicit device parameter associated with the quantum devices.

The computer-implemented method may further include obtaining measurements data relating to the observable device aspects from a quantum device under observation. The computer-implemented method may further include using the trained machine learning model, processing the measurements data obtained from the observed quantum device to infer values for the at least one implicit device parameter associated with the observed quantum device.

In another example, the present disclosure relates to a computer-implemented method for predicting values of implicit device parameters for a quantum device having nanowires. The computer-implemented method includes training a machine learning model to create a mapping between a first set of images related to observable device aspects associated with the quantum devices and at least one implicit device parameter associated with the quantum devices.

The computer-implemented method may further include obtaining a second set of images relating to the observable device aspects from a quantum device under observation. The computer-implemented method may further include using the trained machine learning model, processing the second set of images to infer values for the at least one implicit device parameter associated with the observed quantum device.

In yet another example, the present disclosure relates to a system configured to train a machine learning model to create a mapping between a first set of images related to observable device aspects associated with quantum devices and at least one implicit device parameter associated with the quantum devices.

The system is further configured to obtain a second set of images relating to the observable device aspects from a quantum device under observation. The system is further configured to, using the trained machine learning model, process the second set of images to infer values for the at least one implicit device parameter associated with the observed quantum device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The present disclosure is illustrated by way of example and is not limited by the accompanying figures, in which like references indicate similar elements. Elements in the figures are illustrated for simplicity and clarity and have not necessarily been drawn to scale.

FIG. 1 shows local conductance plots for two different quantum devices in accordance with one example;

FIG. 2 shows non-local conductance plots for the same two quantum devices described earlier with respect to FIG. 1 in accordance with one example;

FIG. 3 shows local conductance plots for another two different quantum devices in accordance with one example;

FIG. 4 shows non-local conductance plots for the same two quantum devices described with respect to FIG. 3 in accordance with one example;

FIG. 5 shows local conductance plots for yet another two different quantum devices in accordance with one example;

FIG. 6 shows non-local conductance plots for the same two quantum devices described with respect to FIG. 5 in accordance with one example;

FIG. 7 shows box plots of the predicted spin-orbit coupling (SOC) values for four different device types in accordance with one example;

FIG. 8 is a block diagram of a computing system for the estimation of implicit device parameters in accordance with one example;

FIG. 9 is a flowchart of a computer-implemented method for predicting values of implicit device parameters for a quantum device in accordance with one example; and

FIG. 10 is a flowchart of another computer-implemented method for predicting values of implicit device parameters for a quantum device in accordance with one example.

### DETAILED DESCRIPTION

Examples described in this disclosure relate to predicting the values of implicit device parameters for a quantum device. Quantum devices, including topological devices, can be used to enable quantum computers. Such quantum computers require reliable reproduction of a stable topological phase of matter that supports non-Abelian quasiparticles or detects and processes quantum information through protected operations, such as braiding.

Certain topological devices can be used to support two phases—one trivial and the other topological. As used herein, the terms topological and trivial refer to the phases of the superconductor sections (e.g., nanowire sections) that are tuned using electrostatic gates to form topological or trivial superconducting sections. Topological devices allow one to measure a topological phase transition in a 2-dimensional electron gas (2DEG) nanowire device with a single or multiple occupied sub-bands and normal-superconducting (NS) junctions for probing the device from the sides. As an example, the wire is defined by the combination of a narrow superconducting strip and one or more layers of gate electrodes. These gate electrodes deplete the surrounding 2DEG, confining the strip in a channel under the superconductor and controlling the chemical potential in the nanowire. The superconducting strip (partly) screens the electric fields from the gate electrodes defining a wire. At the same time, the superconducting strip induces superconductivity via the proximity effect. Another set of gates can be used to open and close the junction and optionally control the chemical potential in the attached quantum dots. The device can then be used, among other things, to create a Majorana zero mode-based quantum computer having qubits.

Majorana zero mode (MZM) qubits require rapidly configuring couplings between different pairs of MZMs for qubit operations and measurement. As used herein, the term qubit refers to any quantum system that can be in a superposition of two quantum states, 0 and 1. As an example of devices that can be used with such a quantum system, topological devices formed from a single superconducting wire patterned on a two-dimensional electron gas (2DEG) are described. Different segments of the wire can be tuned using electrostatic gates to form trivial or topological superconducting sections, with Majorana zero modes at their interface. These gates can also be used to control the density in the 2DEG to deplete certain sections and define semiconducting regions that can form tunnel junctions. Each qubit may store information in either four or six Majorana zero modes (MZMs) and can be measured in any Pauli basis.

The topological device may be operated such that Majorana zero modes (MZMs) are formed at the ends of a section of the nanowire. In sum, electrostatic gates around the superconductor can be used to define an adjacent semiconducting region consisting of junctions, quantum dots, and transport leads, with all other parts of the 2DEG fully depleted. There are junctions between the MZMs and neighboring semiconductors (QDs or transport leads) and junctions between two semiconductors (QDs and transport leads). The plunger gates, the cutter gates, the quantum dot gates, and the helper gates can be supplied voltages via voltage waveforms generated by a control system associated with the topological device. Such a control system may include oscillators, switches, finite state machines, and a memory. As an example, the memory may be implemented as one or more multi-bit registers for allowing pulse-patterns to be stored.

As an example, the 2DEG underlying the gates may be manufactured by forming a series of layers of semiconductors on a substrate (e.g., using any of indium phosphide (InP) substrate, indium arsenide (InAs), indium antimonide (InSb), mercury cadmium telluride (HgCdTe), or any appropriate combination of materials selected from groups II, III, IV, V, or VI of the periodic table, or any ternary compounds of three different atoms of materials selected from groups II, III, IV, V, or VI of the periodic table). As an example, the 2DEG may further include a buffer layer (e.g., an indium aluminum arsenide (InAlAs) layer) formed over the substrate. The 2DEG may further include a quantum well layer (e.g., an indium arsenide (InAs) layer) formed over the buffer layer, and a barrier layer formed over the quantum well layer. Each of these layers may be formed using molecular-beam epitaxy (MBE). As an example, the MBE related process may be performed in an MBE system that allows the deposition of the appropriate materials in a vacuum.

Quantum devices, including the ones having a 2DEG, have both explicit device parameters, such as various voltages applied to the gates, and implicit device parameters. Implicit device parameters of quantum devices relate to those parameters that cannot be measured directly by measurement of the electrical or other properties of the quantum devices. A subset of such implicit device parameters could be measured but would require a substantial amount of time for the measurements associated with such implicit device parameters. Moreover, the measurement of certain device parameters may require fabrication of the quantum device, which is time and resource consuming.

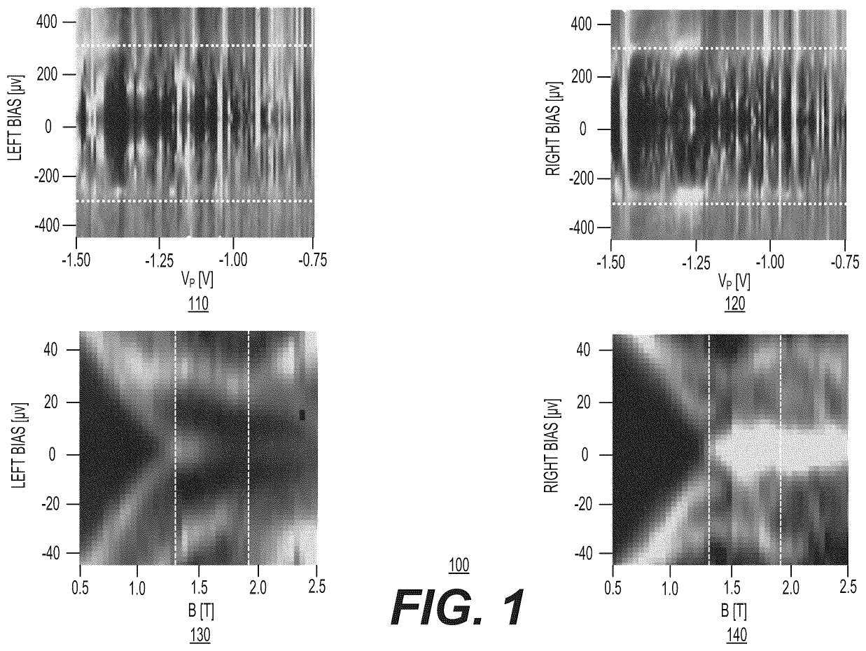

The minimal model of a quantum device with a proximitized nanowire includes a semiconductor nanowire with Rashba spin-orbit interaction coupled to a conventional (s-wave) superconductor. The effective Hamiltonian for such a system is

$$H = {H}_{SM} + {Δ}_{ind} {O}_{SC} , {H}_{SM} + {\int }_{0}^{L} x {ψ}_{σ}^{†} ( x ) {( - \frac{{\partial }_{x}^{2}}{2 m *} - μ + i α {\hat{σ}}_{y} {\partial }_{x} + {V}_{x} {\hat{σ}}_{x} )}_{σ {σ}^{′}} {ψ}_{{σ}^{′}} ( x ) , {O}_{SC} = {\int }_{0}^{L} x ( {ψ}_{↑}^{†} ( x ) {ψ}_{↓}^{†} ( x ) + H . c . ) ,$$

where “SM” and “SC” are abbreviations for, respectively, semiconductor and superconductor, and m*, μ, and α are the effective mass, chemical potential, and Rashba spin-orbit coupling, respectively. Vₓ is the Zeeman splitting due to the applied magnetic field B along the nanowire: Vₓ=g_{SM}μ_{B}B/2, where g_{SM} and μ_{B} are, respectively, the Landé g-factor (the Landé g-factor can be further re-normalized, and each of these values is referred to as g-factor as part of the present disclosure) and Bohr magneton. The proximity to the s-wave superconductor is effectively described by the pairing operator O_{SC}, while Δ_{ind} is the induced pairing potential. Implicit device parameters include the chemical potential (μ), and the Rashba spin-orbit coupling (α), which is referred to as simply the spin-orbit coupling (SOC), and the semiconductor coupling. Implicit device parameters further include the disorder level, the g-factor, the lever arm, or other device parameters that cannot be directly measured. In one example, the lever arm can be represented by dμ/dVp, where μ is the chemical potential and Vₚ is the plunger gate voltage referred to in the context of the plots described with respect to FIGS. 1-6.

Implicit device parameter spin-orbit coupling (SOC) is one of the key parameters in the Bogoliubov-de Gennes (BdG) Hamiltonian. The (BdG) Hamiltonian describes particle-hole transport in one-dimensional semiconductor nanowire. The SOC parameter of a quantum nanowire cannot be measured directly and must be inferred from measurable transport properties. For additional context, a reference: Morteza Aghaee et al., InAs-Al hybrid devices passing the topological gap protocol, Phys. Rev. B 107, 245423 (2023) (referred to herein as the Aghaee reference) is incorporated herein by reference. Without limiting the scope of the incorporation by reference, specific portions of this reference are described or identified, as necessary. As described in section II.E. of the Aghaee reference, the effective Hamiltonian (or similar ones) of a device model can be modified to include the effect of the disorder in physical quantum devices.

The systems and methods described herein use measurement data, including transport measurement data, which is obtained from the simulated quantum devices that have nanowires. As part of these simulations, the implicit device parameters, including the SOC, can be set at will. As an example, the simulation program can be used to set up spin-orbit coupling between 1 to 10 meV nm and the semiconductor coupling between 0 to 1 eV. With the various combinations of these values, the simulation program can generate simulated measurements data.

Next, by applying machine learning (ML) techniques, one can create an approximate inverse mapping of the measurements data to the implicit device parameters. In one example, first, simulated data for a large collection of device models with different pre-set values of the implicit device parameter (e.g., SOC) is generated. Then a predictive machine learning model (ML model) is trained where (conversely) the observation variables are the inputs and the implicit device parameter (e.g., SOC) is the output variable. When applied to the data collected using experiments on a nanowire, such an ML model allows one to estimate the likely value of the relevant implicit device parameter along with a confidence interval around it.

Examples described herein relate to a two-stage process for estimation of the implicit device parameters (e.g., spin-orbit coupling (SOC), the semiconductor coupling, the chemical potential (μ), the disorder level, the g-factor, and the lever arm). The first stage of the two-stage process includes using the observable statistics from device model simulations to estimate the implicit device parameters, such as spin-orbit coupling (SOC). Simulated data is used to build and validate statistical predictive model(s) (including machine learning (ML) model(s)) relating the observables to the implicit device parameter(s). The ML model(s) can be trained based on the simulated data for a large collection of models of quantum devices with nanowires. Various machine learning techniques can be used to train the ML model(s). In one example, ML model(s) may be trained to perform regression analysis. Appropriate supervised machine learning techniques for regression analysis include Artificial Neural Networks, Support Vector Machines, k-Nearest Neighbors (k-NN), and linear regression. In another example, ML model(s) may be trained to first perform image classification (or selection) and then perform the regression analysis.

As part of the second stage of the two-stage process, the ML model(s), which were created as part of the first stage, can be used to predict the implicit device parameter(s) (e.g., the SOC) based on the observations associated with a physical quantum device. In other words, the ML model(s) can be used to infer estimated implicit device parameters (e.g., the SOC) for the physical quantum devices based on the observations associated with such physical quantum devices.

In one example, the ML model(s) are trained using images based on simulated data or measured data for various quantum device models. The images may include local conductance plots, non-local conductance plots, or other images based on data relating to the quantum device models of interest. Simulations (e.g., transport simulations) can include three-dimensional models of devices that include the electrostatic environment defined by the set of gate voltages for such devices. The simulations may include three-dimensional (3D) simulations of the quantum devices that include self-consistent electrostatics, orbital magnetic field contributions, and effects related to the coupling of the superconductor with the semiconductor. The simulations can further be validated using spectroscopy and Hall bar measurements.

Instead of performing time-consuming local conductance measurements as part of scanning the topological parameter regime, one can use radio frequency (RF) reflectometry techniques to measure surrogates for local conductance measurements. RF reflectometry measurements of the local conductance values on both the left side and on the right side of the device as a function of the bias, the corresponding cutter gate voltages, the plunger gate voltage, and the magnetic field can be performed. For a selected gate voltage set, transport simulations can be performed to calculate the scattering matrix of the system. The local and the non-local conductance values can then be obtained.

As an example, FIG. 1 shows local conductance plots 100 for two different quantum devices. Local conductance plot 110 shows a plot of the local conductance (G_{LL}) values for the left side of a simulated device, where the local conductance values are measured in units of e²/h, where e is the electronic charge and his Planck's constant. Local conductance plot 110 shows the local conductance (G_{LL}) values in relation to the left bias voltage and the plunger gate voltage (Vₚ). Local conductance plot 120 shows a plot of the local conductance (G_{RR}) values for right side of the simulated device, which are also measured in units of e²/h, where e is the electronic charge and h is Planck's constant. Local conductance plot 120 shows the local conductance (G_{RR}) values in relation to the right bias voltage and the plunger gate voltage (Vₚ). Local conductance plot 130 shows a plot of local conductance (G_{LL}) values for a different quantum device model. Local conductance plot 130 shows the local conductance (G_{LL}) values in relation to the left bias voltage and the plunger gate voltage (Vₚ). Local conductance plot 140 shows a plot of local conductance (G_{RR}) values for the different quantum device model, as well. Local conductance plot 140 shows the local conductance (G_{RR}) values in relation to the right bias voltage and the plunger gate voltage (Vₚ). Although FIG. 1 shows gray-scaled images, the plots shown in FIG. 1 can have color with a corresponding color scale indicative of the plotted values.

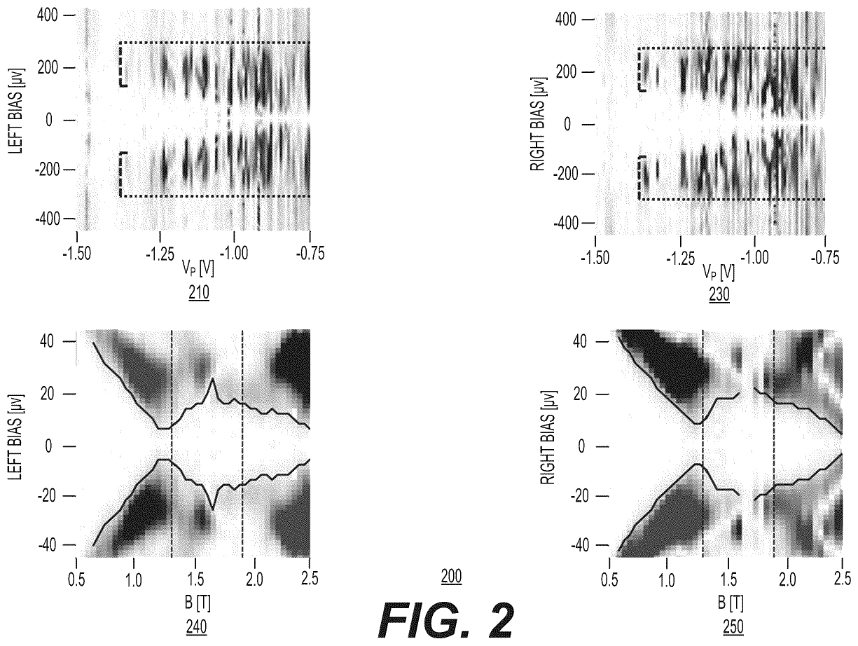

As another example of the images, FIG. 2 shows non-local conductance plots 200 for the same two quantum devices discussed earlier with respect to FIG. 1. Non-local conductance plot 210 shows a plot of the non-local conductance (G_{RL}) values for the simulated device, where the non-local conductance values are measured in units of e²/h, where e is the electronic charge and h is Planck's constant. Non-local conductance plot 220 shows a plot of the non-local conductance (G_{LR}) values for the simulated device, which are also measured in units of e²/h, where e is the electronic charge and h is Planck's constant. Non-local conductance plot 230 shows a plot of the non-local conductance (G_{RL}) values for the other simulated device, where the non-local conductance values are measured in units of e²/h, where e is the electronic charge and h is Planck's constant. Non-local conductance plot 240 shows a plot of the non-local conductance (G_{LR}) values for the other simulated device, which are also measured in units of e²/h, where e is the electronic charge and his Planck's constant. Although FIG. 2 shows gray-scaled images, the plots shown in FIG. 2 can have color with a corresponding color scale indicative of the plotted values.

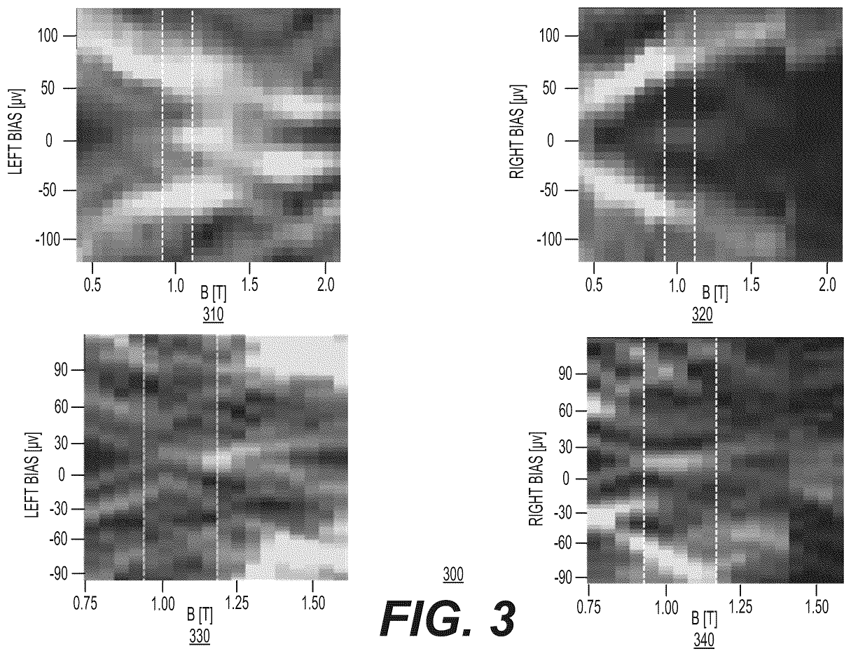

As another example of the images, FIG. 3 shows local conductance plots 300 for another two different quantum devices. Local conductance plot 310 shows a plot of the local conductance (G_{LL}) values for the left side of a simulated device, where the local conductance values are measured in units of e²/h, where e is the electronic charge and h is Planck's constant. Local conductance plot 310 shows the local conductance (G_{LL}) values in relation to the left bias voltage and the plunger gate voltage (Vₚ). Local conductance plot 320 shows a plot of the local conductance (G_{RR}) values for right side of the simulated device, which are also measured in units of e²/h, where e is the electronic charge and h is Planck's constant. Local conductance plot 320 shows the local conductance (G_{RR}) values in relation to the right bias voltage and the plunger gate voltage (Vₚ). Local conductance plot 330 shows a plot of local conductance (G_{LL}) values for a different quantum device model. Local conductance plot 330 shows the local conductance (G_{LL}) values in relation to the left bias voltage and the plunger gate voltage (Vₚ). Local conductance plot 340 shows a plot of local conductance (G_{RR}) values for the different quantum device model, as well. Local conductance plot 340 shows the local conductance (G_{RR}) values in relation to the right bias voltage and the plunger gate voltage (Vₚ). Although FIG. 3 shows gray-scaled images, the plots shown in FIG. 3 can have color with a corresponding color scale indicative of the plotted values.

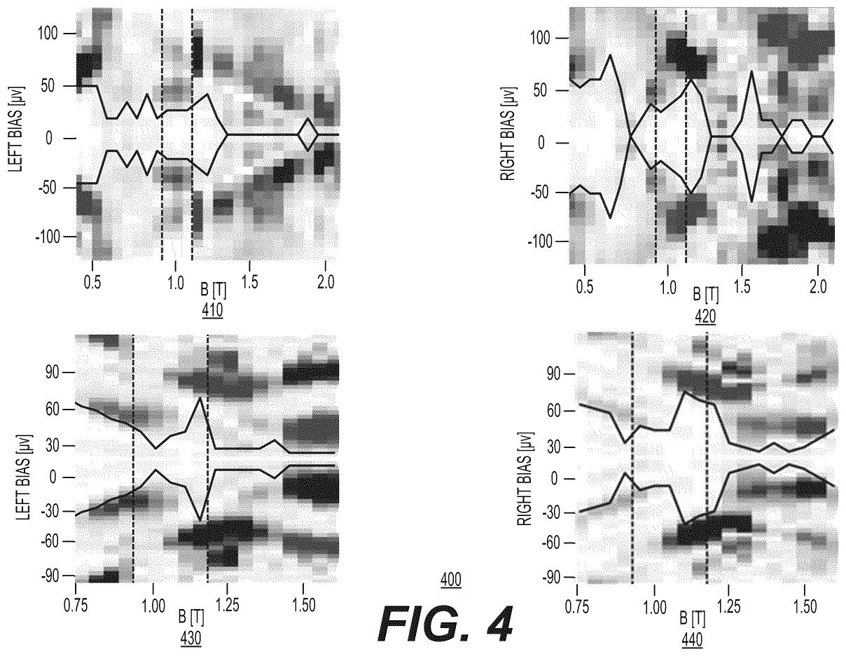

As another example of the images, FIG. 4 shows non-local conductance plots 400 for the same two quantum devices discussed earlier with respect to FIG. 3. Non-local conductance plot 410 shows a plot of the non-local conductance (G_{RL}) values for the simulated device, where the non-local conductance values are measured in units of e²/h, where e is the electronic charge and h is Planck's constant. Non-local conductance plot 420 shows a plot of the non-local conductance (G_{LR}) values for the simulated device, which are also measured in units of e²/h, where e is the electronic charge and h is Planck's constant. Non-local conductance plot 430 shows a plot of the non-local conductance (G_{RL}) values for the other simulated device, where the non-local conductance values are measured in units of e²/h, where e is the electronic charge and h is Planck's constant. Non-local conductance plot 440 shows a plot of the non-local conductance (G_{LR}) values for the other simulated device, which are also measured in units of e²/h, where e is the electronic charge and h is Planck's constant. Although FIG. 4 shows gray-scaled images, the plots shown in FIG. 4 can have color with a corresponding color scale indicative of the plotted values.

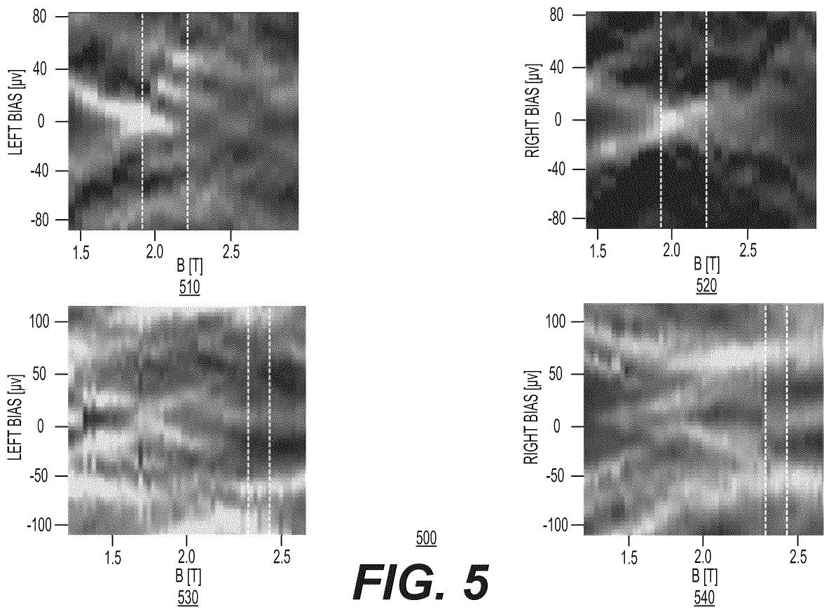

As yet another example, FIG. 5 shows simulated local conductance plots 500 for yet another two different quantum devices. Similar to as described earlier, local conductance plot 510 shows a plot of the local conductance (G_{LL}) values for the left side of a simulated device, where the local conductance values are measured in units of e²/h, where e is the electronic charge and h is Planck's constant. Local conductance plot 510 shows the local conductance (G_{LL}) values in relation to the left bias voltage and the plunger gate voltage (Vₚ). Simulated local conductance plot 520 shows a plot of the local conductance (G_{RR}) values for right side of the simulated device, which are also measured in units of e²/h, where e is the electronic charge and h is Planck's constant. Local conductance plot 520 shows the local conductance (G_{RR}) values in relation to the right bias voltage and the plunger gate voltage (Vₚ). Local conductance plot 530 shows a plot of local conductance (G_{LL}) values for a different quantum device model. Local conductance plot 530 shows the local conductance (G_{LL}) values in relation to the left bias voltage and the plunger gate voltage (Vₚ). Local conductance plot 540 shows a plot of local conductance (G_{RR}) values for the different quantum device model, as well. Local conductance plot 540 shows the local conductance (G_{RR}) values in relation to the right bias voltage and the plunger gate voltage (Vₚ). Although FIG. 5 shows gray-scaled images, the plots shown in FIG. 5 can have color with a corresponding color scale indicative of the plotted values.

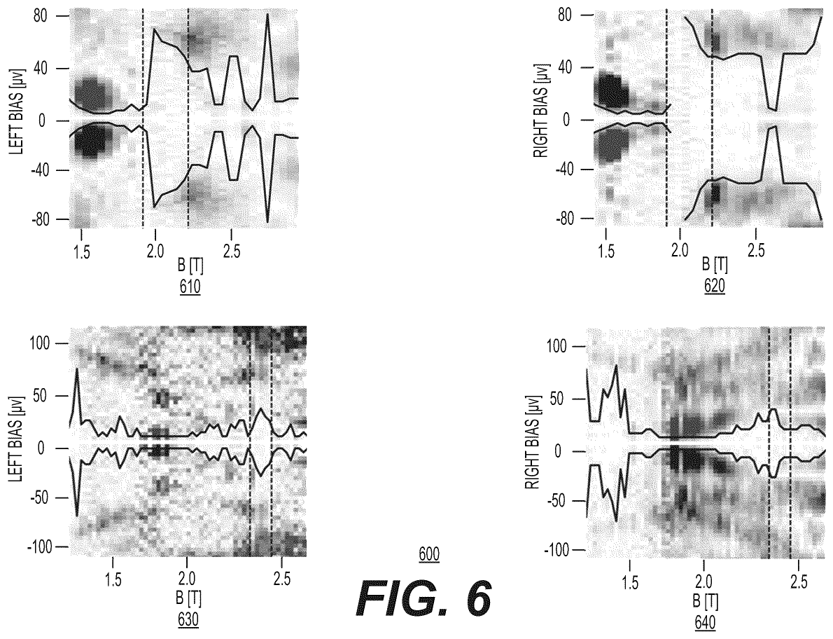

As another example of the images, FIG. 6 shows non-local conductance plots 600 for the same two different quantum devices discussed earlier with respect to FIG. 5. Non-local conductance plot 610 shows a plot of the non-local conductance (G_{RL}) values for the simulated device, where the non-local conductance values are measured in units of e²/h, where e is the electronic charge and h is Planck's constant. Non-local conductance plot 620 shows a plot of the non-local conductance (G_{LR}) values for the simulated device, which are also measured in units of e²/h, where e is the electronic charge and h is Planck's constant. Non-local conductance plot 630 shows a plot of the non-local conductance (G_{RL}) values for the other simulated device, where the non-local conductance values are measured in units of e²/h, where e is the electronic charge and h is Planck's constant. Non-local conductance plot 640 shows a plot of the non-local conductance (G_{LR}) values for the other simulated device, which are also measured in units of e²/h, where e is the electronic charge and his Planck's constant. Although FIG. 6 shows gray-scaled images, the plots shown in FIG. 6 can have color with a corresponding color scale indicative of the plotted values. In addition, although FIGS. 2-6 show local conductance plots and non-local conductance plots as examples of images, other types of plots, graphs, or phase diagrams that can be generated from simulated measurements can also be used as images for further classification and processing. Indeed, plots can be created for each design of a quantum device, where different designs can include different stacks and materials. Table 1 below shows examples of the variability among quantum devices based on their design and material stacks.

| | | | Other Parameters (length of the wire, |
|---|---|---|---|
| | | | width of the wire, thickness of the oxide, |
| | | | the dielectric constant of the oxide, |
| | | | barrier thickness and composition, |
| | Material | Gate | quantum well thickness, and buffer |
| Device | Stack | Layers | composition and thickness) |
| Device A | Type 1 | Single | Selected values for the one or more of the |
| | | | above parameters |
| Device B | Type 2 | Double | Selected values for the one or more of the |
| | | | above parameters |
| Device C | Type 1 | Double | Selected values for the one or more of the |
| | | | above parameters |
| . . . | . . . | . . . | . . . |
| Device ZZ | Type N | Single | Selected values for the one or more of the |
| | | | above parameters |

As shown in table 1 above, quantum devices can vary from each other in many respects. Each of these devices can be fabricated and simulated in order to observe and record various local and non-local transport properties associated with these devices. In addition, the local conductance plots and the non-local conductance plots described earlier can be generated for such devices. Moreover, the local conductance plots and the non-local conductance plots can be further refined, as needed, before additional processing. The generated images can also be pre-processed before further processing to ensure that they are normalized and have similar shapes and sizes to allow further image processing to be more reliable.

In general, one can implement a supervised learning algorithm that can be trained based on input data and once trained, it can make predictions or prescriptions based on the training. Any of the learning and inference techniques such as Linear Regression, Support Vector Machine (SVM) set up for regression, Random Forest set up for regression, Gradient-boosting trees set up for regression and neural networks may be used. Nearest neighbor methods may be used to find (or limit) a number of training samples closest in distance to a representative sample, and label these. The number of samples could be a user-defined number (e.g., k-Nearest neighbors (k-NN)) or the number of samples could vary based on a radius-based learning algorithm. Such algorithms could be used to classify observable device aspects, including the images described earlier. Next, linear regression may be used. As an example, linear regression may include modeling the past relationship between independent variables and dependent output variables.

Trained neural networks of various types can be used. Neural networks may include artificial neurons used to create an input layer, one or more hidden layers, and an output layer. Each layer may be encoded as matrices or vectors of weights expressed in the form of coefficients or constants that might have been obtained via off-line training of the neural network. Neural networks may be implemented as Recurrent Neural Networks (RNNs), Long Short Term Memory (LSTM) neural networks, or Gated Recurrent Unit (GRUs). All of the information required by a supervised learning-based model may be translated into vector representations corresponding to any of these techniques.

Taking the LSTM example, an LSTM network may comprise a sequence of repeating RNN layers or other types of layers. Each layer of the LSTM network may consume an input at a given time step, e.g., a layer's state from a previous time step, and may produce a new set of outputs or states. In the case of using the LSTM, a portion of an image may be encoded into a single vector or multiple vectors. As an example, a portion of an image may be encoded as a single vector. Each portion of the image may be encoded into an individual layer (e.g., a particular time step) of an LSTM network. An LSTM layer may be described using a set of equations, such as the ones below:

$${i}_{t} = σ ( {W}_{xi} xt + {W}_{hi} {h}_{t - 1} + {W}_{ci} {c}_{t - 1} + {b}_{i} )$$

$${t}_{c} = σ ( {W}_{xf} {x}_{t} + {W}_{hf} {h}_{t - 1} + {W}_{cf} {c}_{t - 1} + {b}_{f} )$$

$${c}_{t} = {f}_{t} {c}_{t - 1} {i}_{t} tanh ( {W}_{xc} {x}_{t} + {W}_{hc} {h}_{t - 1} + {b}_{c} )$$

$${o}_{t} = σ ( {W}_{xo} {x}_{t} + {W}_{ho} {h}_{t - 1} + {W}_{co} {c}_{t} + {b}_{o} )$$

$${h}_{t} = {o}_{t} tanh ( {c}_{t} )$$

In this example, inside each LSTM layer, the inputs and hidden states may be processed using a combination of vector operations (e.g., dot-product, inner product, or vector addition) or non-linear operations, if needed.

As another example, a convolutional neural network (CNN) that includes multiple convolution layers and pooling layers can be trained based on the generated and pre-processed images. Once trained, the convolution layers can be used to convolve kernels with smaller sections of an image to generate convolved features as outputs. Interleaved pooling layers (e.g., max pooling layers, mean pooling layers, or average pooling layers) can be used to take a small region of the convolved outputs and sub-sample it to produce a single output. Pooling can help reduce the number of parameters to be computed while making the CNN more effective. Finally, fully connected layers can take the output of all of the neurons in the previous layer and generate an output for the CNN. Additional layers, including layers for introducing non-linearity before the pooling operations can be added to the CNN. Once trained using the generated images, the CNN can be used as part of the inferencing stage.

Since the implicit device parameter value, such as the SOC could be anywhere between the range of values (e.g., values, such as 1.1, 2.4, or 4.5 that fall within the range of values from 1 to 10), regression can be used to predict the floating point value for the SOC. Thus, the combination of the image processing and regression allows one to not merely produce a whole integer value, but instead produce a floating point estimate of the value with confidence intervals.

Having trained ML model(s), measurements data obtained from the observed quantum device can be used to infer values for the at least one implicit device parameter associated with the observed quantum device. The observed quantum device can be a physical implementation of a quantum device being evaluated. The obtained measurements data can include observable device statistics associated with the quantum devices, which can, in turn, relate to the local conductance values and/or non-local conductance values associated with such devices.

Certain measurement configurations can be configured to measure the conductance of sections of a nanowire included in a quantum device. The quantum device can have a superconductor located under both plunger gates and junction gates. The superconductor can be coupled to a contact that can be selectively grounded. The nanowire can be configured to have multiple gate-defined sections with varying lengths. Contacts can be formed to allow coupling to the semiconductor quantum well. Coupling to the superconductor can be controlled by junction gates. The junction gates for the section under measurement can be set to a positive voltage to contact the semiconductor. The conductance values of a section of the nanowire can be obtained by varying the plunger gate voltage of this section while all other gates are set to negative voltages to deplete all unwanted semiconductor states. The nonlocal conductance can then be measured with the nanowire (the superconductor) grounded. This measurement is then repeated for all sections of the nanowire. The measured local conductance values and the nonlocal conductance values for the quantum device under observation can be plotted in a similar fashion as described earlier with respect to FIGS. 1-6. The plunger gates and the junction gates may be supplied voltages via voltage waveforms generated by a control system (not shown) associated with the quantum device. Such a control system may include oscillators, switches, finite state machines, and a memory. As an example, the memory may be implemented as one or more multi-bit registers for allowing scan-patterns and pulse-patterns to be stored.

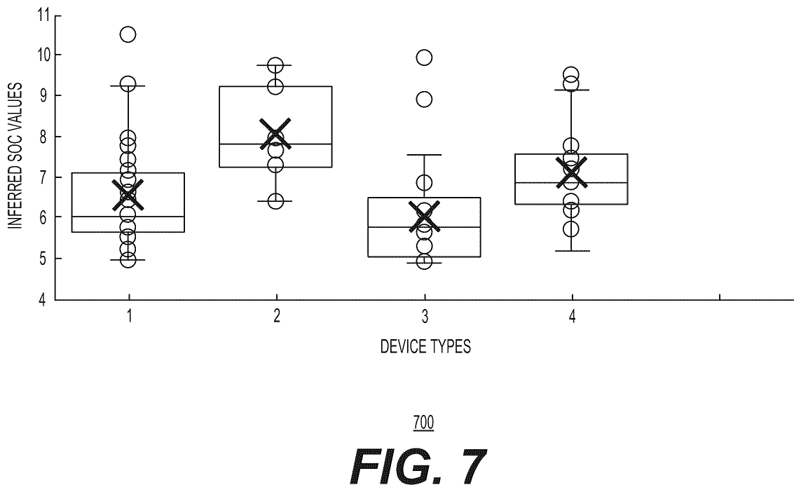

FIG. 7 shows box plots 700 of the predicted SOC values for four different device types in accordance with one example. Box plots 700 can be obtained using the trained ML model to infer the SOC estimates for the four different types of physical devices. Each of box plots 700 shows the middle 50% of the inferred SOC values within the respective box for each device type. The horizontal line in each of the boxes corresponding to box plots 700 shows the median inferred SOC value for each device type. The upper whisker for each of box plots 700 shows the top 25% of the inferred SOC values. The lower whisker for each of box plots 700 shows the bottom 25% of the inferred SOC values. In this example, each of the device types corresponds to a quantum device with a different growth stack. Similar box plots or other similar output can be obtained by using the trained ML models described herein. As an example, similar box plots can be obtained for other implicit device parameters, such as the chemical potential and the semiconductor coupling.

As part of one example use of the methods described herein, advantageously the predicted implicit device parameters for the quantum devices can be used to improve the application of the topological gap protocol (TGP) to the quantum devices being analyzed. TGP is used to identify whether there are regions in the experimental parameter space that show signatures consistent with a topological phase. In the topological phase of a superconducting wire, Majorana zero modes (MZMs) are localized at the boundaries between the topological section and the trivial section. Assuming that the physical length (L) of the wire is smaller than the localization length, one is likely to observe a nonzero bulk transport gap. As part of the TGP, the presence of MZMs and a bulk transport gap is detected by measuring certain differential conductances as a function of the plunger voltage and other control variables. Because of the high-dimensional nature of the parameter space of the TGP, it is important to narrow the measured parameter range. The predicted implicit device parameters for the quantum devices can help in accomplishing this objective. As an example, the predicted values for the implicit device parameter SOC can be used to explore only those regions of interest of the parameter space that relate to the predicted SOC values. In addition, assuming the predicted values of the implicit device parameters, such as the SOC, are outside the range of values that suggests the presence of a topological gap, then one can abandon further efforts to pursue such quantum devices.

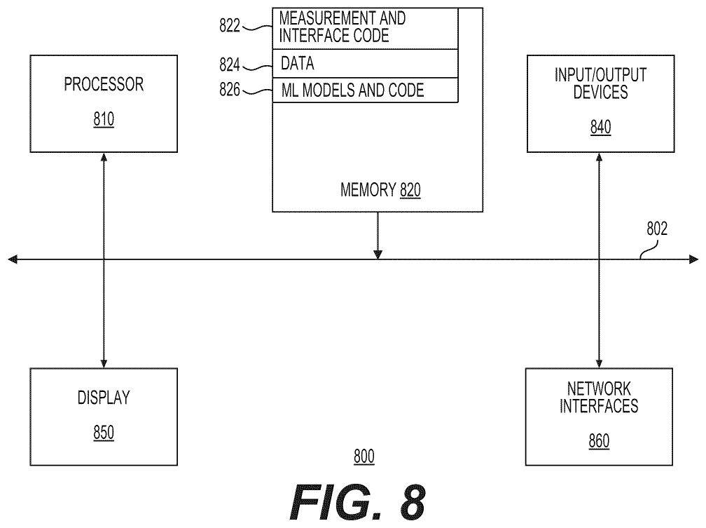

FIG. 8 is a block diagram of a computing system 800 for estimation of implicit device parameters in accordance with one example. Computing system 800 includes a processor 810, a memory 820, input/output devices 840, display 850, and network interfaces 860 interconnected via a bus system 802. Memory 820 may include measurement and interface code 822, data 824 (including simulated data and real data, images created from the simulated data or real data referred to earlier, or other types of data used as part of the methods described herein), and ML models and code 826.

Measurement and interface code 822 may include program instructions that, when executed by processor 810, allow computing system 800 to enable some aspects of the performance of the methods described herein. In addition, measurement and interface code 822 may include libraries or other code for allowing processor 810 to display relevant information (e.g., simulated data-based plots) on display 850. Measurement and interface code 822 may also allow input/output devices 840 to receive or transmit information associated with the methods described herein.

Data 824 includes synthetic transport measurement data, which is obtained from nanowire simulations. In addition, data 824 includes simulated data for a large collection of synthetic nanowire models with different pre-set values of the implicit device parameters, including the SOC. In addition to simulated data, data 824 includes data collected using experiments on a nanowire.

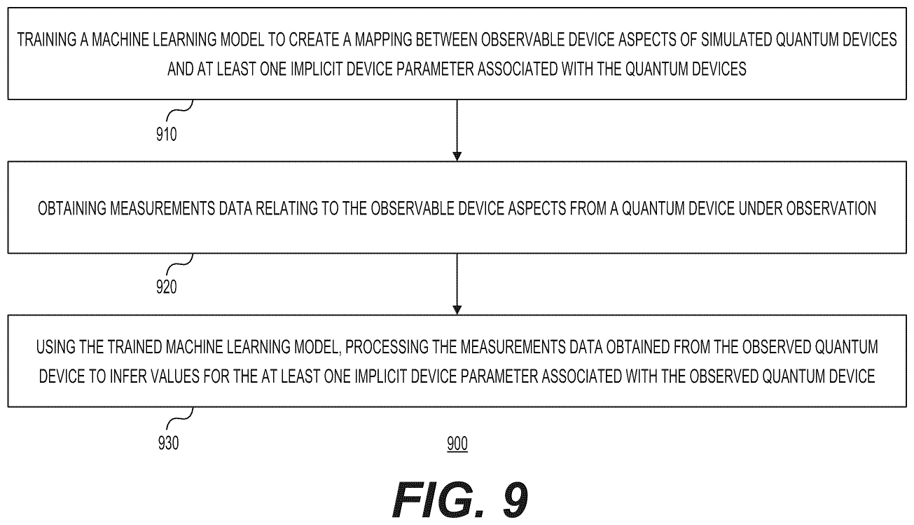

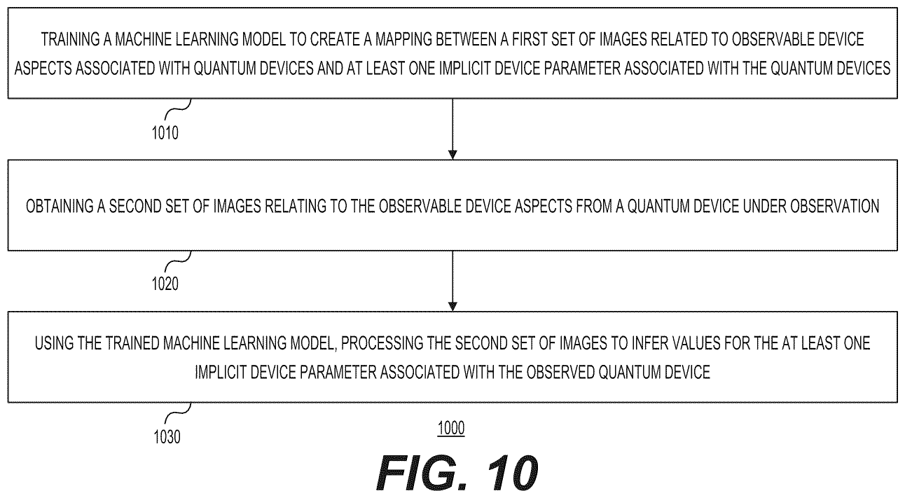

ML models and code 826 may include instructions for executing steps described with respect to the various methods described herein. As an example, ML models and code 826 may include software libraries and other code for executing steps associated with the method described with respect to FIGS. 9 and 10 and the other aspects of the steps described herein. Although FIG. 8 shows a certain number of components of computing system 800 arranged in a certain way, additional or fewer components arranged differently may also be used. In addition, although memory 820 shows certain blocks of code, the functionality provided by this code may be combined or distributed. In addition, the various blocks of code may be stored in non-transitory computer-readable media, such as non-volatile media and/or volatile media. Non-volatile media include, for example, a hard disk, a solid state drive, a magnetic disk or tape, an optical disk or tape, a flash memory, an EPROM, NVRAM, PRAM, or other such media, or networked versions of such media. Volatile media include, for example, dynamic memory such as DRAM, SRAM, a cache, or other such media.

FIG. 9 is a flowchart 900 of a computer-implemented method for predicting values of implicit device parameters for a quantum device. Steps associated with the method can be performed using instructions and data stored in the memory of computing system 800 of FIG. 8. Step 910 includes training a machine learning model to create a mapping between observable device aspects of simulated quantum devices and at least one implicit device parameter associated with the quantum devices. The implicit device parameters include at least one of spin-orbit coupling, semiconductor coupling, or chemical potential. The observable device aspects may relate to observable device statistics associated with the quantum devices. As an example, the observable device aspects may relate to local conductance values associated with the quantum devices. In another example, the observable device aspects may relate to non-local conductance values associated with the quantum devices. The local conductance values and the non-local conductance values may be obtained from synthetic transport measurements data derived from simulations of the quantum devices having nanowires. As explained earlier, as part of these simulations, the implicit device parameters, including the SOC, can be set at will.

Step 920 includes obtaining measurements data relating to the observable device aspects from a quantum device under observation. As explained earlier, certain measurement configurations can be configured to measure the conductance of sections of a nanowire included in a quantum device. Other configurations can be used to obtain other measurements data, including transport measurements data.

Step 930 includes using the trained machine learning model, processing the measurements data obtained from the observed quantum device to infer values for the at least one implicit device parameter associated with the observed quantum device. As an example, as part of this step, the trained machine learning model(s) (ML model) take measurements data obtained from the observed quantum device as inputs and infer the implicit device parameter (e.g., the SOC). As described earlier, when applied to the data collected using experiments on a nanowire, such an ML model allows one to estimate the likely value of the SOC along with a confidence interval around it.

FIG. 10 is a flowchart 1000 of another computer-implemented method for predicting values of implicit device parameters for a quantum device in accordance with one example. Steps associated with the method can be performed using instructions and data stored in the memory of computing system 800 of FIG. 8. Step 1010 includes training a machine learning model to create a mapping between a first set of images related to observable device aspects associated with the quantum devices and at least one implicit device parameter associated with the quantum devices. The implicit device parameters include at least one of spin-orbit coupling, semiconductor coupling, or chemical potential. The observable device aspects may relate to observable device statistics associated with the quantum devices. As an example, the observable device aspects may relate to local conductance values associated with the quantum devices, and wherein each of the first set of images and the second set of images comprise local conductance plots. In another example, the observable device aspects may relate to non-local conductance values associated with the quantum devices, and wherein each of the first set of images and the second set of images comprise non-local conductance plots. The examples of the images, including the conductance plots, are described earlier with respect to FIGS. 1-6. Each of the first set of images and the second set of images may also comprise phase diagrams associated with the quantum devices. The local conductance values and the non-local conductance values may be obtained from synthetic transport measurements data derived from simulations of the quantum devices having nanowires. As explained earlier, as part of these simulations, the implicit device parameters, including the SOC, can be set at will.

Step 1020 includes obtaining a second set of images relating to the observable device aspects from a quantum device under observation. As explained earlier, certain measurement configurations can be configured to measure the conductance of sections of a nanowire included in a quantum device. Other configurations can be used to obtain other measurements data, including transport measurements data.

Step 1030 includes using the trained machine learning model, processing the second set of images to infer values for the at least one implicit device parameter associated with the observed quantum device. As an example, as part of this step, the trained machine learning model(s) (ML model) can take the second set of images for the observed quantum device as inputs and infer the implicit device parameter (e.g., the SOC). As described earlier, when applied to the data collected using experiments on a nanowire, such an ML model allows one to estimate the likely value of the SOC (or other such implicit device parameters) along with a confidence interval around it.

In conclusion, the present disclosure relates to a computer-implemented method for predicting values of implicit device parameters for a quantum device having nanowires. The computer-implemented method may include training a machine learning model to create a mapping between observable device aspects of quantum devices and at least one implicit device parameter associated with the quantum devices.

The computer-implemented method may further include obtaining measurements data relating to the observable device aspects from a quantum device under observation. The computer-implemented method may further include using the trained machine learning model, processing the measurements data obtained from the observed quantum device to infer values for the at least one implicit device parameter associated with the observed quantum device.

As part of this method, the one or more implicit device parameters may comprise at least one of a spin-orbit coupling, a semiconductor coupling, a chemical potential, a disorder level, a g-factor, or a lever arm. The observable device aspects may relate to observable device statistics associated with the quantum devices.

Moreover, the observable device aspects may relate to local conductance values associated with the quantum devices. In addition, or in the alternative, the device aspects may relate to non-local conductance values associated with the quantum devices. Finally, the observable device aspects may relate to measurable transport properties associated with the quantum devices. The machine learning model may comprise a neural network.

In another example, the present disclosure relates to a computer-implemented method for predicting values of implicit device parameters for a quantum device having nanowires. The computer-implemented method includes training a machine learning model to create a mapping between a first set of images related to observable device aspects associated with the quantum devices and at least one implicit device parameter associated with the quantum devices.

The computer-implemented method may further include obtaining a second set of images relating to the observable device aspects from a quantum device under observation. The computer-implemented method may further include using the trained machine learning model, processing the second set of images to infer values for the at least one implicit device parameter associated with the observed quantum device.

As part of this method, the one or more implicit device parameters may comprise at least one of a spin-orbit coupling, a semiconductor coupling, a chemical potential, a disorder level, a g-factor, or a lever arm. The observable device aspects may relate to local conductance values associated with the quantum devices, where each of the first set of images and the second set of images comprises a local conductance plot. Alternatively, or additionally, the observable device aspects may relate to non-local conductance values associated with the quantum devices, where each of the first set of images and the second set of images comprises a non-local conductance plot.

Moreover, each of the first set of images and the second set of images may also comprise a phase diagram associated with the quantum devices. The observable device aspects may relate to measurable transport properties associated with the quantum devices.

In yet another example, the present disclosure relates to a system configured to train a machine learning model to create a mapping between a first set of images related to observable device aspects associated with quantum devices and at least one implicit device parameter associated with the quantum devices.

The system is further configured to obtain a second set of images relating to the observable device aspects from a quantum device under observation. The system is further configured to, using the trained machine learning model, process the second set of images to infer values for the at least one implicit device parameter associated with the observed quantum device.

As part of this system, the machine learning model may comprise a neural network model. The at least one implicit device parameter may comprise one of a spin-orbit coupling, a semiconductor coupling, a chemical potential, a disorder level, a g-factor, or a lever arm.

The observable device aspects may relate to local conductance values associated with the quantum devices, where each of the first set of images and the second set of images may comprise a local conductance plot. Alternatively, or additionally, the observable device aspects may relate to non-local conductance values associated with the quantum devices, where each of the first set of images and the second set of images may comprise a non-local conductance plot.

Finally, each of the first set of images and the second set of images may comprise a phase diagram associated with the quantum devices. The observable device aspects may also relate to measurable transport properties associated with the quantum devices.

It is to be understood that the systems, devices, methods, and components described herein are merely examples. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or inter-medial components. Likewise, any two components so associated can also be viewed as being “operably connected,” or “coupled,” to each other to achieve the desired functionality. Merely because a component, which may be an apparatus, a structure, a device, a system, or any other implementation of a functionality, is described herein as being coupled to another component does not mean that the components are necessarily separate components. As an example, a component A described as being coupled to another component B may be a sub-component of the component B, the component B may be a sub-component of the component A, or components A and B may be a combined sub-component of another component C.

The functionality associated with some examples described in this disclosure can also include instructions stored in a non-transitory media. The term “non-transitory media” as used herein refers to any media storing data and/or instructions that cause a machine to operate in a specific manner. Exemplary non-transitory media include non-volatile media and/or volatile media. Non-volatile media include, for example, a hard disk, a solid-state drive, a magnetic disk or tape, an optical disk or tape, a flash memory, an EPROM, NVRAM, PRAM, or other such media, or networked versions of such media. Volatile media include, for example, dynamic memory such as DRAM, SRAM, a cache, or other such media. Non-transitory media is distinct from, but can be used in conjunction with transmission media. Transmission media is used for transferring data and/or instruction to or from a machine. Exemplary transmission media include coaxial cables, fiber-optic cables, copper wires, and wireless media, such as radio waves.

Furthermore, those skilled in the art will recognize that boundaries between the functionality of the above described operations are merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

Although the disclosure provides specific examples, various modifications and changes can be made without departing from the scope of the disclosure as set forth in the claims below. Accordingly, the specification and figures are to be regarded in an illustrative rather than a restrictive sense, and all such modifications are intended to be included within the scope of the present disclosure. Any benefits, advantages, or solutions to problems that are described herein with regard to a specific example are not intended to be construed as a critical, required, or essential feature or element of any or all the claims.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles.

Unless stated otherwise, terms such as “first” and “second” are used to arbitrarily distinguish between the elements such terms describe. Thus, these terms are not necessarily intended to indicate temporal or other prioritization of such elements.

What is claimed;:

1. A computer-implemented method for predicting values of implicit device parameters for a quantum device having nanowires, the method comprising:
training a machine learning model to create a mapping between observable device aspects of quantum devices and at least one implicit device parameter associated with the quantum devices;
obtaining measurements data relating to the observable device aspects from a quantum device under observation; and
using the trained machine learning model, processing the measurements data obtained from the observed quantum device to infer values for the at least one implicit device parameter associated with the observed quantum device.

2. The computer-implemented method of claim 1, wherein the one or more implicit device parameters comprise at least one of a spin-orbit coupling, a semiconductor coupling, a chemical potential, a disorder level, a g-factor, or a lever arm.

3. The computer-implemented method of claim 1, wherein the observable device aspects relate to observable device statistics associated with the quantum devices.

4. The computer-implemented method of claim 1, wherein the observable device aspects relate to local conductance values associated with the quantum devices.

5. The computer-implemented method of claim 1, wherein the observable device aspects relate to non-local conductance values associated with the quantum devices.

6. The computer-implemented method of claim 1, wherein the observable device aspects relate to measurable transport properties associated with the quantum devices.

7. The computer-implemented method of claim 1, wherein the machine learning model comprises a neural network.

8. A computer-implemented method for predicting values of implicit device parameters for a quantum device having nanowires, the method comprising:
training a machine learning model to create a mapping between a first set of images related to observable device aspects associated with the quantum devices and at least one implicit device parameter associated with the quantum devices;
obtaining a second set of images relating to the observable device aspects from a quantum device under observation; and
using the trained machine learning model, processing the second set of images to infer values for the at least one implicit device parameter associated with the observed quantum device.

9. The computer-implemented method of claim 8, wherein the one or more implicit device parameters comprise at least one of a spin-orbit coupling, a semiconductor coupling, a chemical potential, a disorder level, a g-factor, or a lever arm.

10. The computer-implemented method of claim 8, wherein the observable device aspects relate to local conductance values associated with the quantum devices, and wherein each of the first set of images and the second set of images comprises a local conductance plot.

11. The computer-implemented method of claim 10, wherein the observable device aspects relate to non-local conductance values associated with the quantum devices, and wherein each of the first set of images and the second set of images comprises a non-local conductance plot.

12. The computer-implemented method of claim 8, wherein each of the first set of images and the second set of images comprises a phase diagram associated with the quantum devices.

13. The computer-implemented method of claim 8, wherein the observable device aspects relate to measurable transport properties associated with the quantum devices.

14. A system for predicting values of implicit device parameters for a quantum device having nanowires, the system configured to:
train a machine learning model to create a mapping between a first set of images related to observable device aspects associated with quantum devices and at least one implicit device parameter associated with the quantum devices;
obtain a second set of images relating to the observable device aspects from a quantum device under observation; and
using the trained machine learning model, process the second set of images to infer values for the at least one implicit device parameter associated with the observed quantum device.

15. The system of claim 14, wherein the machine learning model comprises a neural network model.

16. The system of claim 14, wherein the at least one implicit device parameter comprises one of a spin-orbit coupling, a semiconductor coupling, a chemical potential, a disorder level, a g-factor, or a lever arm.

17. The system of claim 14, wherein the observable device aspects relate to local conductance values associated with the quantum devices, and wherein each of the first set of images and the second set of images comprises a local conductance plot.

18. The system of claim 14, wherein the observable device aspects relate to non-local conductance values associated with the quantum devices, and wherein each of the first set of images and the second set of images comprises a non-local conductance plot.

19. The system of claim 14, wherein each of the first set of images and the second set of images comprises a phase diagram associated with the quantum devices.

20. The system of claim 14, wherein the observable device aspects relate to measurable transport properties associated with the quantum devices.
